(19) United States
(12) Patent Application Publication
(10) Pub. No.: US 2012/0057006 A1
(43) Pub. Date: Mar. 8, 2012

(54) AUTOSTEREOSCOPIC DISPLAY SYSTEM AND METHOD

(75) Inventors: DANIEL M. JOSEPH, Los Angeles, CA (US); MARK A. REICHOW, Valencia, CA (US)

(73) Assignee: DISNEY ENTERPRISES, INC., BURBANK, CA (US)

(21) Appl. No.: 12/877,190

(22) Filed: Sep. 8, 2010

(51) Int. Cl. H04N 13/04

(52) U.S. Cl. 348/59; 348/51; 348/E13.029

(57) ABSTRACT

An autostereoscopy apparatus that typically includes a passive autostereoscopic panel such as a lenticular poster. The panel has a front surface, a back surface, and a plurality of static images. Dining use, the autostereoscopic panel is configured or designed to reflect light to generate, passively or without power, a three dimensional (3D) display of images based on the static images. The apparatus includes an image source selectively operating to project two dimensional (2D) images onto the back surface of the autostereoscopic panel, which is non-opaque such that the two dimensional images are projected outward from the front surface within the 3D display, e.g., the 2D images are inserted or injected into the volumetric display so as to also appear to have depth and dimensions. The two dimensional images may be video images precision masked based on at least one of the static images.

### BACKGROUND

1. Field of the Description

The present description relates, in general, to the illusion of autostereoscopic or three dimensional (3D) image generation and projection, and, more particularly, to systems and methods for producing autostereoscopic images (i.e., autostereoscopic graphic displays providing a volumetric display to viewers rather than projected images requiring a viewing technology such as particular glasses to be properly viewed).

2. Relevant Background

There is a growing trend toward using 3D projection techniques in theatres and in home entertainment systems including video games and computer-based displays, and, to render computer generated (CG) images for 3D projection (e.g., stereoscopic images), a pair of horizontally offset, simulated cameras is used to visually represent the animated models. More specifically, with true or conventional 3D implementations using 3D projection techniques, the right eye and the left eye images can be delivered separately to display the same scene or images from separate perspectives so that a viewer sees a three dimensional composite, e.g., certain characters or objects appear nearer than the screen and other appear farther away than the screen. Stereoscopy, stereoscopic imaging, and 3D imaging are labels for any technique capable of recording 3D visual information or creating the illusion of depth in an image. Often, the illusion of depth in a photograph, movie, or other two-dimensional image is created by presenting a slightly different image to each eye. In most animated 3D projection systems, depth perception in the brain is achieved by providing two different images to the viewer's eyes representing two perspectives of the same object with a minor deviation similar to the perspectives that both eyes naturally receive in binocular vision.

The images or image frames used to produce such a 3D output are often called stereoscopic images or a stereoscopic image stream because the 3D effect is due to stereoscopic perception by the viewer. A frame is a single image at a specific point in time, and motion or animation is achieved by showing many frames per second (fps) such as 24 to 30 fps. The frames may include images or content from a live action movie filmed with two cameras or a rendered animation that is imaged or filmed with two camera locations. Stereoscopic perception results from the presentation of two horizontally offset images or frames with one or more object slightly offset to the viewer's left and right eyes, e.g., a left eye image stream and a right eye image stream of the same object. The amount of offset between the elements of left and right eye images determines the depth at which the elements are perceived in the resulting stereo image. An object appears to protrude toward the observer and away from the neutral plane or screen when the position or coordinates of the left eye image are crossed with those of the right eye image (e.g., negative parallax). In contrast, an object appears to recede or be behind the screen when the position or coordinates of the left eye image and the right image are not crossed (e.g., a positive parallax results).

Many techniques have been devised and developed for projecting stereoscopic images to achieve a 3D effect. One technique is to provide left and right eye images for a single, offset two-dimensional image and displaying them alternately, e.g., using 3D switching or similar devices. A viewer is provided with liquid crystal shuttered spectacles or shutter glasses to view the left and the right eye images. The shuttered spectacles are synchronized with the display signal to admit a corresponding image one eye at a time. More specifically, the shutter for the right eye is opened when the right eye image is displayed and the liquid crystal shutter for the left eye is opened when the left eye image is displayed. In this way, the observer's brain merges or fuses the left and right eye images to create the perception of depth.

Another technique for providing stereoscopic viewing is the use of anaglyph or color lens anaglyph. An anaglyph is an image generally consisting of two distinctly colored, and preferably, complementary colored, images. The theory of anaglyph is the same as the technique described above in which the observer is provided separate left and right eye images, and the horizontal offset in the images provides the illusion of depth. The observer views the anaglyph consisting of two images of the same object in two different colors, such as red and blue-green, and shifted horizontally. The observer wearing anaglyph spectacles views the images through lenses of matching colors. In this manner, the observer sees, for example, only the blue-green tinted image with the blue-green lens, and only the red tinted image with the red lens, thus providing separate images to each eye. The advantages of this implementation are that the cost of anaglyph spectacles is lower than that of liquid crystal shuttered spectacles and there is no need for providing an external signal to synchronize the anaglyph spectacles.

In 3D projection systems using polarization techniques, the viewer may be provided glasses with appropriate polarizing filters such that the alternating right-left eye images are seen with the appropriate eye based on the displayed stereoscopic images having appropriate polarization (two images are superimposed on a screen, such as a silver screen to preserve polarization, through orthogonal polarizing filters). Other devices have been produced in which the images are provided to the viewer concurrently with a right eye image stream provided to the right eye and a left eye image stream provided to the left eye. Still other devices produce an auto-stereoscopic display via stereoscopic conversion from an input color image and a disparity map, which typically is created based on offset right and left eye images. While these display or projection systems may differ, each typically requires a stereographic image as input in which a left eye image and a slightly offset right eye image of a single scene from offset cameras or differing perspectives are provided to create a presentation with the appearance of depth.

There is a continuous desire and need to provide new techniques that provide cost effective, eye-catching content with depth and dimension. For example, it is desirable to grab the attention of crowds in shopping malls, on busy streets, in amusement parks, and other crowded facilities such as airports and entertainment arenas. As discussed above, 3D imagery is one exciting way to appeal to viewers and hold their attention. However, the use of 3D imagery has, in the past, been limited by a number of issues. Typically, 3D projection is used only in low light environments and is not particularly effective in applications where there is a significant amount of ambient light such as an outdoor venue during the daytime (e.g., an amusement park or athletic stadium in the morning or afternoon). Further, 3D projection technologies generally require the viewer to wear special viewing glasses, which is often inconvenient for many applications and can significantly add to costs. Hence, there remains a need for systems and methods for providing stereoscopic or volumetric displays in a cost effective manner and in the presence of higher ambient light levels.

### SUMMARY

The present description addresses the above problems by providing an autostereoscopic display system that inserts or adds two-dimensional (2D) images, via rear projection, emissive display, or the like, into a static, passive three-dimensional (3D) displayed image provided by a passive 3D imaging element (such as, but not limited to, a lenticular poster or similar stereoscopic panel).

The inventors understood that multiple forms of stereoscopic technologies have been around for many years. For example, lenticular posters combine a transparent substrate having numerous lenticules or linear lenses with a printed image made up of numerous interlaced images that provide a passive, unchanging 3D display to a viewer depending on their point of view (POV) relative to the lenticules. These images are magical or interesting in, part because of their illusion of depth, space, and 3D without the need for special viewing glasses, i.e., the effect may be thought of as “autostereoscopic.” In contrast, most 3D projection technology such as 3D movies requires colored, switching lenses, or other eyewear to achieve the stereoscopic effect).

However, the inventors also understood that the amount of informational or other content that a lenticular or other conventional stereoscopic poster or panel was limited to the information printed in the interlaced images (e.g., a sign or similar limited content). The display was static in that that printed image never changed and only provided repeated animation when a viewer changed their POV relative to the poster's front surface (e.g., a small amount of animation such as via a relatively small number of frames of a video clip that is simply repeated by changing viewing position or moving the poster).

Hence, the inventors determined it would be desirable to provide a new autostereoscopic display system. The new display system uses the 3D virtual space (e.g., along the Z-plane extending outward from a front surface of an autostereoscopic panel) created by an autostereoscopic panel (such as a lenticular-based panel). The display system includes an image source operable to project onto or display on a rear or back surface of the autostereoscopic panel so as to insert or add video or still characters and/or content inside the passive 3D virtual space. For example, the 3D virtual space may include a background image, an intermediate image, and a foreground image, and a video image may be projected onto or displayed on the back surface of the autostereoscopic panel to move among these three, layered images such as in a plane designed to contain these images or in/between one or more of the planes of the images. The video image is a 2D image but may be precision masked to enhance the 3D effect achieved such as to only be displayed in portions of each image that makes sense to a viewer (e.g., stars above a static background image of mountains or a building, fire displayed above burners of a gas stove provided as a static intermediate image, and a character that walks through a door in a background image disappears behind an intermediate image and reappears in larger size adjacent a foreground image).

The display system allows a designer or operator of a display system to dynamically augment the 3D virtual space within the stereoscopic print. In one embodiment, this is achieved by integrating digital media by way of projection or emissive displays to create a range of effects such as an animated talking character provided 3D imagery by its positioning relative to the concurrently created 3D virtual space and such as atmospheric special effects like billowing smoke or a roaring fire within the 3D virtual space (e.g., smoke over a building's chimney, fire over a campfire or torch, and so on within the scenic image).

More particularly, an autostereoscopy apparatus is provided that typically includes a passive autostereoscopic panel such as a lenticular poster or the like. The panel has a front surface, a back surface, and at least one ink layer providing a plurality of static images. During use, the autostereoscopic panel is configured or designed to reflect light striking the front surface so as to display a three dimensional (3D) display of images based on the static images, e.g., the light passes into the panel (in the case of backed posters or the like with a white paper or plastic that is translucent) and is reflected from a backing surface to show printed images. The apparatus further includes an image source selectively operating to project two dimensional (2D) images onto the back surface of the stereoscopic panel. The back surface of the panel is non-opaque such that the two dimensional images are projected outward from the front surface within the 3D display (e.g., the 2D images are inserted or injected into the volumetric display so as to also appear to have depth and dimensions).

In some embodiments of the apparatus, one or more of the two dimensional images are video images. These video images may be precision masked based on at least one of the static images (e.g., masked so as to only display in a window of static image of building or the like). The masking may result in the video images only being displayed within a display area that is a smaller subset of a projection surface corresponding to the front surface (e.g., a plane orthogonal to the Z plane extending out from the front surface). Each of the video images (e.g., movie clips) may be displayed over a range of X-Y coordinates of a projection surface corresponding to the front surface. In this manner, displayed images associated with the video images are displayed in two or more layers of the 3D display.

In some embodiments of the display apparatus, the stereoscopic panel includes a lenticular sheet including lenticules on the front surface with the static images provided as sets of interlaced images and the back surface may be provided by a backing layer covering the ink layer that is at least partially translucent. In some cases, the image source is an emissive display, such as a liquid crystal display (LCD) or plasma display, with a display surface positioned proximate to the back surface of the stereoscopic panel.

According to another aspect of the description, an apparatus is provided or described for generating a volumetric display. This apparatus may include a passive depth-producing element with a front surface and a rear surface. The passive depth-producing element is responsive to light from a light source external to the apparatus to display at least a background image and a foreground image at differing depths relative to the front surface.

The apparatus further includes a source of digital media including a two-dimensional video image and an emissive display with a monitor screen. The emissive display is linked to or communicates with the digital media source, and the emissive display operates to display the two-dimensional video image via the monitor screen. To this end, the monitor screen is positioned adjacent the rear surface of the passive depth-producing element. The two-dimensional video image may be designed or configured to move between, a position proximate to the background image and a position proximate to the foreground image by means of media design tricks/effects (e.g., not actual moving Z-plane). In this way, a volumetric display is provided including the background image, the foreground image, and the two-dimensional video image that appears to have changing positions within the Z plane due to the movement relative to the background and foreground images.

In some embodiments of the apparatus, the two-dimensional video image is masked based on at least one of the background and foreground images to be projected from predefined areas of the front surface of the passive depth-producing element. In such cases, the predefined areas for projection include areas where the at least one of the background and foreground images are not displayed from the front surface of the passive depth-producing element.

According to another aspect of this description (e.g., a projected method portion of the description), an autostereoscopic display method is provided that includes positioning a stereoscopic panel in an area with a light source (such as the Sun, outdoor lighting, building facility lights, and so on). The positioned stereoscopic panel displays a volumetric display in response to light from the light source that includes at least two static images at differing depths along the Z plane relative to the stereoscopic panel. In many cases, the stereoscopic panel has a backing that is at least partially translucent to light. The method also includes projecting light through the backing of the stereoscopic panel. The projected light is visible by a viewer of the stereoscopic panel in the volumetric display. In some implementations of the method, the projected light is moved, during the projecting, at least from first to second positions within the volumetric display, e.g., the first and second positions may correspond to X-Y coordinates in a plane orthogonal to the Z plane.

In some embodiments of the method, the projected light includes 2D video images, whereby a dynamic image is inserted into the volumetric display. In such embodiments, the step/function of projecting the light may be performed by an emissive display with a display screen positioned adjacent the backing of the stereoscopic panel. To provide interactivity, the method may include receiving user input and, prior to the projecting step, modifying or selecting the 2D video images based on the received user input. To enhance the achieved dimensional effect, the 2D video images may be masked using at least one of the static images. The stereoscopic panel may include a lenticular sheet with a layer of interlaced images corresponding to the static images and a backing layer of non-opaque material corresponding to the backing of the stereoscopic panel.

### BRIEF DESCRIPTION OF THE DRAWINGS

FIG. 1 illustrates an autostereoscopic display of one embodiment in functional block form prior to injection of an additional two dimensional (2D) image via operation of an image source (such as an emissive display or the like);

FIG. 2 illustrates the autostereoscopic display of FIG. 1 with the image source being operated or used to project or provide one or more 2D images (still and/or video images) to a back surface of a passive 3D imaging element or stereoscopic panel to create and display a volumetric display with inserted or added still and/or video images (e.g., a 3D image is supplemented with animation to provided an eye-catching autostereoscopic display (i.e., a 3D display not requiring special viewing glasses or other devices);

FIG. 3 is a simplified side or end view of one embodiment of an autostereoscopic display system or apparatus showing use of an emissive display for the 2D image source in combination with a lenticular stereoscopic panel for a passive depth element providing a static depth backdrop for added or inserted 2D images from the 2D image source;

FIGS. 4 and 5 are schematic illustrations (top and front views) of a volumetric display apparatus that uses a display system (such as those shown in FIGS. 1-3) to insert stationary or static 2D images and 2D video images into a 3D or volumetric display;

FIG. 6 illustrates an autostereoscopic or volumetric display that may be provided by one of the display systems described herein showing how 3D images provided by a passive depth element (such as a lenticular poster) may be enhanced with one or more 2D video or motion images (which also causes a viewer to perceive depth in the 2D video images, too); and

FIG. 7 illustrates a functional block diagram of an autostereoscopic display system.

### DETAILED DESCRIPTION OF THE PREFERRED EMBODIMENTS

Briefly, embodiments described herein are directed toward systems and methods of providing enhanced volumetric displays. The displays are autostereoscopic because a viewer may perceive depth or the 3D effects in the displayed image without the use of 3D glasses or eyewear (e.g., no need for colored or switching lenses or the like). The volumetric displays are enhanced in the sense that the displays include added or inserted images that may be stationary or static within the display but more often are moving images or video that provides action in an otherwise static 3D display.

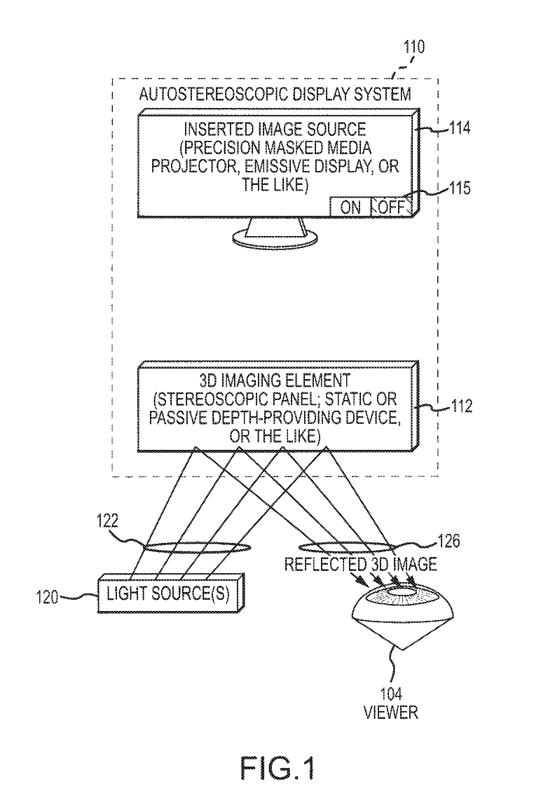

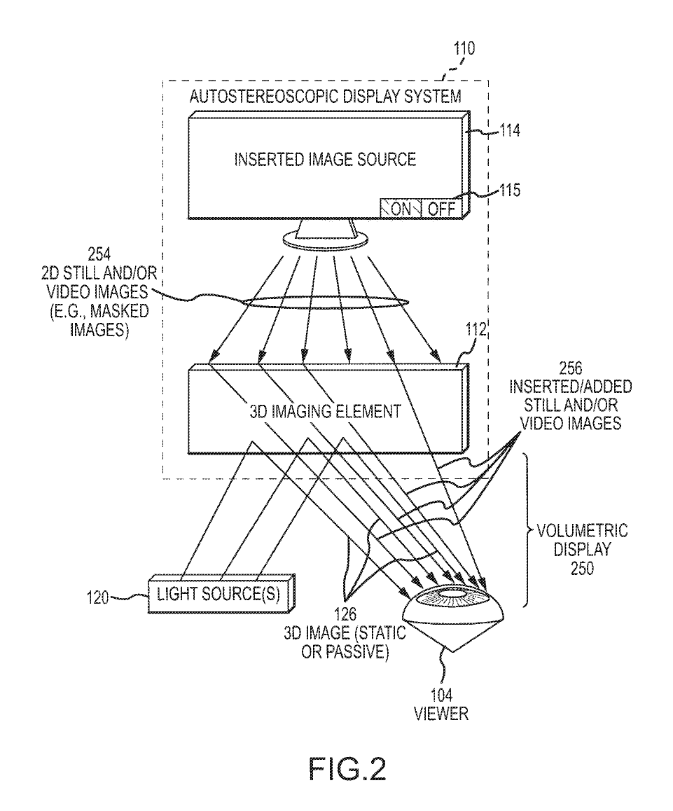

FIGS. 1 and 2 illustrate an autostereoscopic display system 110 that may be used to create a unique volumetric display 250 (or 3D display or stereoscopic display). The display system 110 includes a 3D imaging element 112 (e.g., a lenticular poster or the like with a printed image providing 3D image 126) and an inserted image source 114. FIG. 1 shows the system 110 with the image source 114 turned off (or at least not operating to project/display light and/or images onto the 3D imaging element 112) while FIG. 2 shows the system with the image source 114 turned on (or operating to project/display light and/or images 254 onto the 3D imaging element 112).

The 3D imaging element 112 may be nearly any device that is operable to create a 3D display or image visible by a viewer 104. Generally, the 3D imaging element 112 may use autostereoscopy to display stereoscopic images 126 without the use of special headgear or glasses by the viewer 104, e.g., a device using parallax barrier, lenticular technology, volumetric techniques, and the like. In many cases, the element 112 is selected such that head-tracking is not required as the element 112 is passive without a need to know a position of the eyes of the viewer 104. In some embodiments, the 3D imaging element is a flat panel that employs lenticular lenses of 20 to 40 or more lenticules/lenses per inch (and corresponding interlacing of the underlying image), but with the opaque backing removed (and/or replaced with a non-opaque or at least partially translucent backing layer that reflects light 122 but that also allows light from image source 114 to pass through it and out the front of 3D imaging element 112).

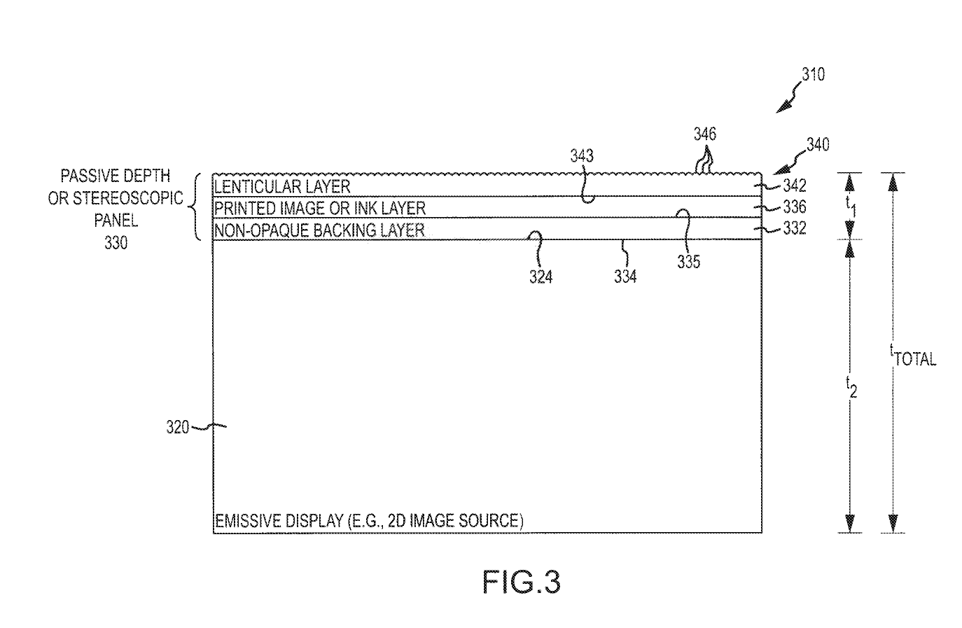

In some preferred embodiments, the 3D imaging element 112 is a passive device that may include a printed image and a lens structure that allows it to receive light 122 from one or more light sources 120 (which may simply be ambient light in the area of the display system 110) and reflect the light 126 to display a 3D image or create a 3D virtual space in a Z-plane for the viewer 104. For example, the 3D imaging element 112 may be a lenticular poster (with a non-opaque, but typically translucent backing) that reflects portions of an interlaced image through lenticules on its exposed or front surface, with the portion reflected or visible in 3D image depending on a POV of viewer 104 relative to the imaging element 112. An example of a display system or apparatus using a lenticular imaging element for element 112 is shown in more detail in FIG. 3.

In some implementations of the display system 110, the element 112 is a large format lenticular sheet, such as those provided by Micro Lens Technology, Inc., with an image up to 48 inches or more in width and up to about 0.25 inches in thickness (e.g., a lenticular sheet of PETG, APET, acrylic resins, or the like may be used for element (or at least the lens array portion) The lens per inch (LPI) may range greatly such as 10 LPI up to about 60 LPI, and some embodiments may use the 3D40 or 3D60 lenticular sheets provided by Micron Lens Technology or similar lenticular products. In some cases, the interlaced images providing the static, reflected 3D image 126 observable by the viewer 104 are printed directly onto the backside (opposite the lenticules) of the lenticular sheet while in other cases the images are printed onto the translucent backing sheet that is then attached to the lenticular sheet with a translucent to transparent adhesive (e.g., an optically clear, pressure-sensitive adhesive such as Lensmount™ Adhesive Film available from Micro Lens Technology, Inc. or the like). A sheet of paper vellum (colored or white) may be attached to the back side of the element 112 to provide a rear projection-type screen when the image source 114 is operated to project or emit light with images 254 onto the back side of element 112 (as discussed below with reference to FIG. 2).

Of course, other 3D imaging technologies and products may also be used for the 3D imaging element. For example, the inventors have also produced display systems 110 in which the imaging element comprises a Screen3D™ product distributed by Kenpren 3D Imaging, Jefferson, Md. These imaging elements 112 do not utilize lenticules and interlaced images but, instead, provide 3D imagery 126 based on a layout of images/content in two dimensions in which virtual depth (spacing along the Z axis/plane or within the Z space) of the different layers of the image 126 may be specified for the display system 110 (e.g., where a foreground image may appear above or outward from the front surface of the imaging element 112, where a background image of the 3D image 126 may appear below or behind the front surface of the imaging element 112, and/or where an intermediate image in 3D image 126 may appear (e.g., upon or near the front surface of the imaging element 112, and so on). The thickness may be 1 to 5 mm or the like and the imaging element may be a sheet or planar device formed of PET, acrylic, PVC, or other translucent to transparent materials with a backing typically provided to cause the light 122 to reflect as 3D image 126 to viewer 104.

An important aspect of imaging element 112 for FIGS. 1 and 2 being that the image 126 has depth or provides a 3D imagery to viewer 104 simply using light 122. The display system 110 includes an inserted image source 114 that in FIG. 1 is off or being operated so as to not provide any light/images to be projected by imaging element 112 to viewer 104. Hence, in FIG. 1, the viewer 104 is only able to view the static and/or repeatable 3D images 126 provided by imaging element 112.

Selectively, though, as shown in FIG. 2, the inserted image source 114 is turned on or operates (as shown at 115) to project, display, or otherwise provide 2D still and/or video images 254 to the 3D imaging element 112. Typically, the images 254 are provided onto all or portions of the rear surface of the imaging element 112, and this rear or back surface is at least partially translucent or even transparent so as to allow the light of images 254 to be transmitted through the thickness of the element 112 and projected outward as inserted or added still and/or video images 256 within the passive/static 3D image 126. The combination of the 3D images 126 and the added 2D images 256 creates a unique volumetric display 250 (or autostereoscopic display or combined imagery) visible by viewer 104.

As is discussed below, the passive 3D image 126 typically has layers (background, intermediate, and foreground) with images, and the inserted 2D images 256 may be selectively provided within the passive images 126 so as to appear to also have depth (e.g., a talking image displayed in a mirror or picture frame that is part of static 3D image 126, a bird that flies from a tree in the background to a birdfeeder in the foreground and that increases in size as it appears to fly forward toward viewer 104, and the like). The passive 3D image 126 is visible in many ambient light situations including when the light source 120 includes sunlight or the like such that the viewer 104 may be a relatively bright environment and be able to see the reflected image 126.

The image source 114, as with the imaging element 112, may take numerous forms to practice the display system 110. For example, the image source 114 may be simply be a light source with the 2D still or video images 254 of FIG. 2 taking the form of white or colored light positioned on all or, more typically, portions of the rear surface of imaging element to inject the still or moving images 256. This may be useful, for example, to light up a passive component of 3D image 126 to change its appearance or to light up different content to cause the attention of the viewer 104 to change over time with insertion of images 256.

In other embodiments, the image source 114 may take the form of a conventional projector that projects images 254 onto the rear or back surface of 3D imaging element 112 using digital or other media stored in or fed to image source 114 when controlled in an on or operating condition 115. In still other cases, the image source 114 may be or include an emissive display, such as a plasma display, a liquid crystal display, a computer monitor, a flat screen television or display, or the like, that is positioned near or even abutting a rear/back surface of the 3D imaging element 112 such that when its displayed media or images 254 are inserted is 2D images 256 in the 3D image 126 to create the volumetric display 250 visible by viewer 104 as shown in FIG. 2. The 3D imaging element 112 may be made to be larger or the same size (and/or shape) as the image source or display source 114. For example, the 3D imaging element 112 may be a 46-inch sheet to cover a 46-inch LCD or other television/computer display or the 3D imaging element 112 may be even larger to provide a large sign or display screen (and the image source 114 may project on all or just a portion of the imaging element 112 with inserted images 254).

FIG. 3 illustrates an autostereoscopic display system 310 that makes use of lenticular technologies to provide a combination of a passive/static 3D images and dynamic 2D images to create a unique volumetric display. The display system 310, in this embodiment, includes an emissive display 320 as the 2D image source, and the emissive display 320 may be nearly any screen-type display such as a liquid crystal display (LCD) with a flat screen 324. The flat screen or monitor surface 324 may be spaced apart from (e.g., to provide an air gap to achieve a particular effect) or simply abut the passive depth element or stereoscopic panel 330 of the display system 310. For example, the panel 330 may be mounted onto the emissive display 320 with an exposed surface 324 of a non-opaque backing layer 332 contacting (or nearly contacting) the emissive display surface 324. The emissive display 320 and/or panel 330 may be arranged with a horizontal or vertical configuration (e.g., landscape or portrait arrangement) to suit a particular application.

The panel 330 may include a lenticular layer or lens layer 340, a printed image or ink layer 336, and a backing layer 332 (or, in some cases, the ink layer 336 may be the backing layer or these two layers may be combined into one). The lenticular layer 340 includes a transparent (or at least translucent) substrate 342 such as formed of acrylic or the like upon which a plurality of lenticules or elongate, linear lenses 346 are provided (e.g., at 10 to 60 LPI or the like). The ink layer 336 includes the artwork to passively produce a stereoscopic display (e.g., interlaced images to provide a 3D image) and may be applied directly or with adhesive to back surface 342 of the substrate 342.

The backing layer 332 may be a sheet of at least partially translucent material (e.g., non-opaque material such as a white or colored paper product or the like) that protects the ink layer 336 (with its inner or upper surface 335 abutting the ink layer 336, which may be printed onto the backing layer 332 in some cases and then applied with adhesive to the surface 343 of substrate 342). More importantly, the non-opaque (and also non-transparent) backing layer 332 may be selected or configured to reflect light passing through the lenticular layer 342 and ink layer 336 back outward from the display system 310 to allow a viewer to observe 3D images.

In some cases, the ink layer or artwork 336 may be printed directly onto the lensed transparent substrate 342 on back, planar surface 343, rather than upon an opaque paper backing that has to be adhesively attached to the lenticular layer 340. The backing layer 332 is non-opaque such that light from the surface 324 of emissive display 320 is projected into or allowed to pass to through the ink and lenticular layers 340 to be injected into or displayed with the static 3D images provided by the artwork 336 and lenticular layer 340. In some cases, it may be possible to eliminate the backing layer 332. In either case, the system 310 effectively integrates media from the emissive display 320 into the Z-plane extending outward from lenticules 346 by attaching the panel 330 onto the surface 324 of the display 320 (with exposed or back surface 334 abutting or placed proximate to surface 324).

Briefly, it will be appreciated that the presence of the stereoscopic printed image 336 sets a viewer's brain up to view a 2D image provided by the emissive display 320 in a particular way, e.g., as having depth because it is viewed concurrently with the 3D images. Particularly, the viewer's brain articulates the 2D media introduced in a portion of the Z-plane by the emissive display 320 as having dimension and depth. In reality, though, the emissive display 320 is preferably operated to present 2D flat media (such as a conventional movie or video clip that may be masked to interact with the content of the various layers of the image produced by artwork of ink layer 336), but, when the integration is done correctly (e.g., via precision masking or the like), a volumetric display is created that can be dynamically built up within a static 3D display (e.g., a 3D stage or set for showing 2D content that magically becomes 3D, too, and also makes the static images exciting and eye-catching).

The use of an emissive display 320 provides the advantage that the display system 310 may be relatively thin. In other words, the illusion of dimension and depth can be achieved with little to no facility impact. As shown, the overall or total thickness, tₜₒₜₐₗ, is made up of the combination of the panel thickness, t₁, and the emissive display thickness, t₂. The panel 330 typically is less than 2 inches thick and, in the case of a lenticular sheet, the thickness, t₁, is generally less than about 0.25 inches. The emissive display 320 may be an LCD, plasma, or other monitor that has a thickness of less than about 10 inches (e.g., less than about 7 inches or the like). Hence, the total thickness, t_{Total}, may be such that the display system 310 could readily be mounted or installed into a 10-inch deep space (or project outward from a mounting surface about 10 inches).

In another embodiment or configuration, a flat image (2D) may be printed and then sandwiched on front of a lenticular sheet or panel. This image may be used to provide a transition effect. For example, a 2D painting becomes three dimensional and then goes back to two dimensions via the operation of the 2D image source.

In one implementation, the inventors intend to use lenticular sheets 340 that may be printed in large sizes up to 48-inches by 96-inches or the like each printed with a set of stereoscopic images in an ink layer 336. The stereoscopic panels 330 would then be mated with an emissive display 320 of matching or appropriate size and shape. The display systems 310 may then be tiled together (next to each other along a wall, for example), to create a larger scene not achievable with one display system 310. This stereoscopic scene would be passive at times but then selectively made dynamic via operation of the emissive displays 320 concurrently, sequentially, or in any combination to achieve a larger volumetric display. The multi-display system scene may be designed to fit into a forced-perspective set, and media from the emissive displays 320 would be projected onto the backs 334 of the panels 330 to create stories and provide attention-holding content. The overall volumetric display may include very large visuals with eye-popping depth and magical illusions in a relatively small facility space.

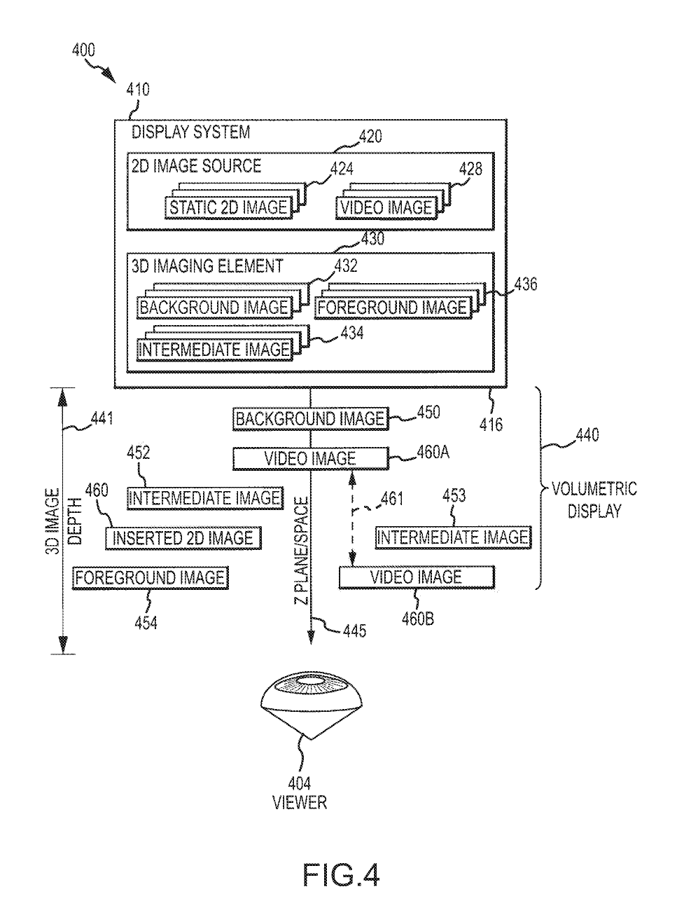

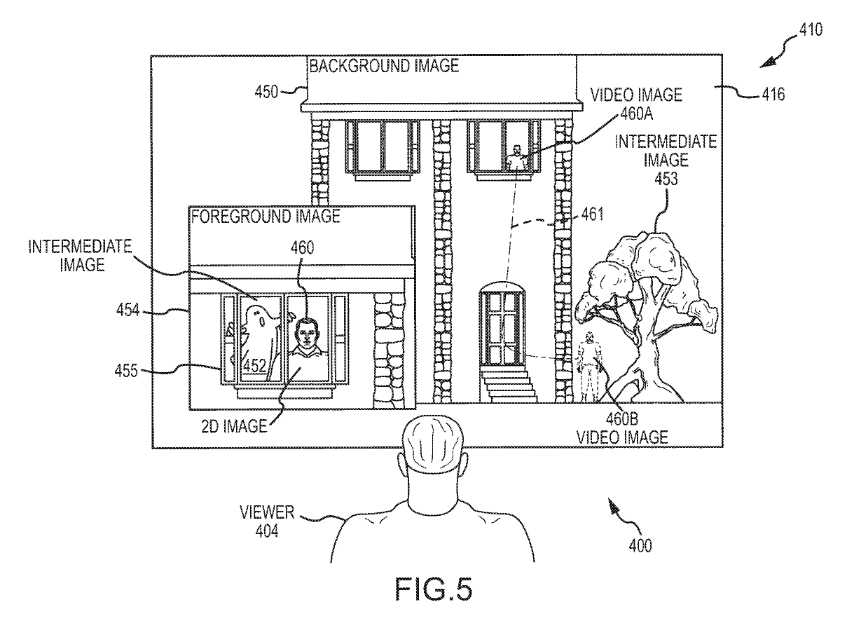

FIGS. 4 and 5 illustrate a volumetric display environment or setting 400 to schematically show a volumetric display 440 that is achievable through use of the autostereoscopic concepts described herein. As shown in the top view of FIG. 4, the setting 400 includes an autostereoscopic display system 410 that is operated to generate a volumetric display 440 observable by a viewer 404 (e.g., a person standing nearby or in front of the front or exposed surface 416 of the display system 410. For example, the front surface 416 may be a surface of the 3D imaging element 430 (e.g., the lenticules when the element 430 comprises a lenticular panel or sheet).

The display system 410 includes the 3D imaging element 430 to create a passive or static portion of the volumetric display 440 with 3D image depth 441 (e.g., images appear to be extending outward or inward from surface 416 in a Z plane/space 445 such that some images are closer to observer 404 and some are farther away from observer 404). To this end, the imaging element 430 includes a two or more images (e.g., printed content, artwork, photographs, and so on) that are arranged in the printing and/or viewable through lenses or viewing technology in the imaging element 430 to be viewed in differing layers or at differing depths 441 in the Z plane 445.

As shown, the 3D imaging element 430 includes, such as within the interlaced images of a print/ink layer in a lenticular embodiment, one or more background images 432, one or more intermediate images 434 (although these are optional in some cases), and one or more foreground images 436. In ambient (and even relatively low) light levels in the environment 400, the viewer 404 views a volumetric display 440 that includes: one or more background images 450 that correspond to background images 432; one or more intermediate images 452, 453 that correspond to intermediate images 434; and one or more foreground images 454 that correspond to foreground images 436. Exemplary images 450, 452, 453, and 454 are shown in FIG. 5, and these images typically are static or are least simply repeating (e.g., change depending on POV to provide some animation) and are considered a passive aspect of the volumetric display 440 seen by viewer 404. However, the passive aspect provided by 3D imaging element 430 via images 450, 452, 453, 454 is an important part of the environment 400 as it creates a perception of depth along the Z plane 445 for viewer 404 such that later added 2D images provided by 2D images source 420 appear to also have depth (e.g., an image by a foreground image 454 will appear to be at or near that level some depth 441 outward from or in front of surface 416).

Specifically, the display system 410 includes the 2D image source 420 (e.g., a projector, an emissive display device, or the like providing media that may or may not be masked to suit the images 432, 434, 436 of imaging element 430) that is selectively operable to dynamically insert or add 2D images into the volumetric display 440. The media or content may be digital content stored in memory of source 420 (or accessible by source 420 or provided in a streaming manner in a wired or wireless manner over a digital communications network).

The media or content may include static or stationary 2D images 424 that when selectively presented (projected onto or included in a display surface abutting the imaging element 430) causes a corresponding image to be added to the volumetric display 440. For example, the image source 420 may operate to display one static 2D image 424 through the 3D imaging element 430, and this may result in an inserted 2D image 460 being visible in volumetric display 440 by viewer 404. The 2D image 460 may be masked so as to only appear in the opening 455 of a foreground image 454 but in front of (or through) intermediate 3D image 452. As a result, the 2D image 460 appears to have depth because the viewer 404 perceives the image 460 as having a depth 441 along the Z plane 445 that is between the foreground image 454 and the intermediate image 452 provided by 3D imaging element 430.

The media or content provided by the 2D image source 420 may also include one or more video-based images or moving/animated images 428. For example, a video image(s) 428 may be a movie clip that allows an animated or filmed character to be inserted into the volumetric display 440 and move about the images 450, 452, 453, 454 to appear to change its 3D image depth 441 in the Z plane. Alternatively, the movie/video image 428 may remain at a particular depth or layer 441 but animate that layer (such as with shooting stars or fireworks shown on in the background of a display 440 or fish swimming in the foreground of display 440 and so on (on or adjacent images from 3D imaging element)).

For example, one of the video images 428 may be chosen for playing/displaying by the image source 420. During its insertion into volumetric display 440, the video image 460A may first be displayed in a background layer 441 with precision masking used to cause the image 460A to appear to be in an opening or space of a background image 450 (e.g., a window or door when background image 450 is a building as shown in FIG. 5). The image 460A may be masked as the movie/video is played so that it is hidden for view for a period of time and then appear moving through other layers. Specifically, the video image 460A may be hidden as the character is inside a building image 450 and then appear to walk out a door, past a tree (intermediate image 453 provided by 3D imaging element 430), and then move in front of the image 453 or adjacent a foreground image 454. This movement through the layers/depths of Z plane/space 445 is shown by arrow 461 joining video images 460A and 460B.

The image 460B may also grow in size to enhance the illusion that the image 460B is closer to viewer 404. In this manner, the volumetric display 440 may include animation or animated characters/objects 460A, 460B that may appear to move between layers of the volumetric display 440 with their 3D image depth 441 changing over time. Further, the display 440 does not have to simply repeat as the 2D image source may operate to play very long movies/images 428 and/or to end one animated sequence provided by an image/digital content 428 and start a new one (which may even be selected in an interactive manner based on input from viewer 404 and/or sensed information regarding the environment 400).

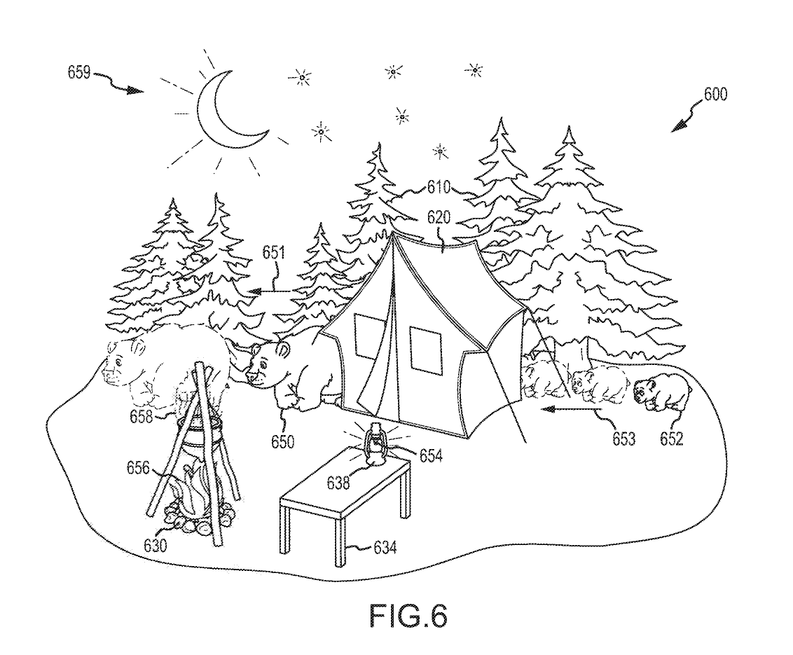

FIG. 6 provides an illustration of a volumetric display 600 that may be provided by operation an autostereoscopic display system described herein. FIG. 6 is provided to further discuss how passive 3D elements may be combined with active or selectively presented 2D elements to create a new and unique 3D or stereoscopic display without the requirement that viewers wear special headgear or glasses (i.e., an autostereoscopic display is created as shown at 600).

The volumetric display 600 includes static or passive image elements that would be generated with a 3D imaging element (such as stereoscopic panel in the form of lenticular sheet with a non-opaque backing) in the form of background images 610 that appear behind the front surface/plane of the 3D imaging element (not shown) as measured along the Z plane; intermediate images 620 that may appear on or near the front surface of the 3D imaging element or at least in front of the background image elements 610; and foreground image elements 630, 634, 638 that appear in front of the front surface of the 3D imaging element as measured along the Z plane (or at least in front of the intermediate images 620). In this way, a display of images 610, 620, 630, 634, 638 provides depth and dimensions. Typically, though, these images are fixed in place or with limited animation that may be provided when a viewer moves to change their POV or the imaging element is moved relative to the viewer's position.

To provide animation and eye-catching content, the volumetric display 600 also includes one or more 2D images that are selectively inserted or injected by operation of a 2D image source (not shown in FIG. 6) (e.g., an emissive display with a monitor exposed to the backing of the 3D imaging element or the like). The added 2D images in display 600 are all video images but that are presented to appear to be on differing layers of the display 600, and the images include a mother bear 650 and a baby bear 652 shown with arrows 651 and 653 to be moving from the right to the left of the display 600. Precision masking is used in the video used to display the images 650, 652 to make the bears appear to have depth or a relative position within the display 600 by causing the bears 650, 652 to disappear as they appear to run behind the tent/intermediate image element 620 and then reappear out the other side (e.g., by masking their display when behind the tent image 620 and then unmasking their display when they reach a position on the other side of the tent image 620). In this way, the bears 650, 652 appear to be at a depth in the Z space between the intermediate images 620 and the background images 610.

The added or inserted 2D images may include a video of a lantern light 654 that is positioned to cause a lantern/foreground image 638 to turn on and light up surrounding image elements 634. The added 2D images may also include a video that provides a movie of a fire 656 that is positioned on or near logs of a fireplace 630 (e.g., a static foreground image) and also a movie of steam 658 positioned “above” a pot of water over fire 656 in campfire 630. Each of these 2D images 654, 656, 658 appears to be in the foreground of the Z space due to the precise positioning of their images near or on 3D foreground images provided by the 3D imaging element. The volumetric display 600 may further include background content that is added by operation of the 2D image source. As shown, added images may include sky elements 659 (e.g., a moon and stars) that appear to be over the background images 610, and, hence, to be behind the intermediate and foreground images or behind the front surface of the 3D imaging element.

All the added images may be added together for concurrent display and/or be added separately or in any combination over time. For example, the moon and stars 659 may initially come up to show that it is nighttime in the campground scene 600 and then the lantern and fire images may be added as shown at 654 and 656. After the fire 656 has “burned” for a period of time, the steam image 658 may be added, and the “smell” of the cooking food may cause the bears 650, 652 to run 651, 653 through the camp scene 600 (and out of the scene). In this way, the volumetric display 600 is changing over time with dynamically added content via operation of a 2D image source (as discussed in reference to FIGS. 1 and 2, for example).

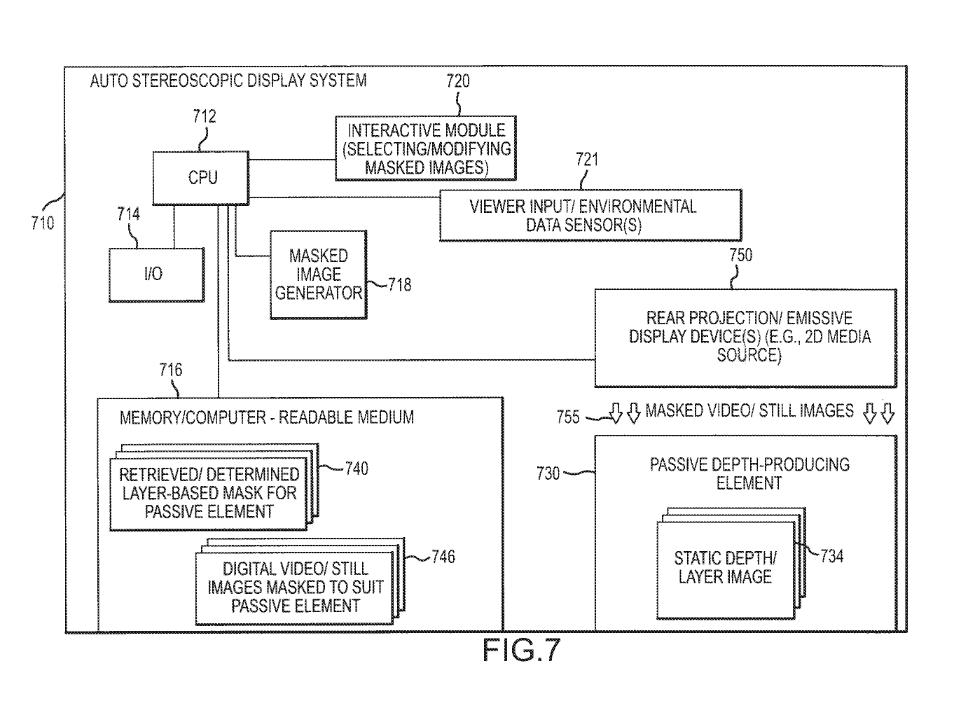

FIG. 7 illustrates with a functional block diagram an autostereoscopic display system 710 of another embodiment. As shown, the display system 710 includes a hardware process or central processing unit 712 (e.g., a computer or electronic controller). The CPU 712 manages operation of input/output devices 714 such as keyboard, a mouse, a touchscreen/touchpad, and the like that allow a user/operator to enter input and printers, monitors, wired/wireless communication devices and the like to output data to a user or other devices. The CPU 712 also manages memory (or computer-readable medium) in the display system 710 or accessible by the system 710.

The CPU 712 may execute code (e.g., software, applications, code devices, and the like) to perform particular functions. For example, the CPU 712 may execute a masked image generator 718. As shown, the display system 710 includes a passive depth-producing element 730 (e.g., a lenticular sheet with printed artwork providing interlaced images) that includes static depth/layer images 734. The memory 716 may include retrieved layer-based masks for one or more of the passive elements 734 or these may be created by the masked image generator 718. For example, one of the images 734 may be a building with windows and a door, and the mask 740 would define space within a plane orthogonal to the Z plane (or parallel to or corresponding to the display surface of the 3D imaging element 730) where images should be projected such as the windows or door (or where images should be masked out such as the walls or other portions of the building). Using this data 740, the masked image generator 718 may be used to create digital video/still images 746 that are precision masked so as to only display in the locations of this projection plane that suit one or more of the layer-based masks 740 for the passive elements 734.

The masked 2D images 746, as discussed above with reference to FIGS. 4-6 may then be displayed in a volumetric display so as to appear to be in the same layer or to a have desired depth with regard to various static 3D image elements 734 provided by depth-producing element 730. This is shown at 755 and is achieved, in this example, by the CPU/controller 712 operating a rear projector/emissive display device 750 such as to project the images onto a back surface of the depth-producing element 730. Also, as discussed above, the device 750 may be operated selectively to display all or portions of the digital content 746 to achieve a desired effect. For example, the display system 710 may include viewer input devices/environmental data sensor(s) 721 that provide data to the CPU 712. This data may be processed by an interactive module run by the CPU 712 to select subsets or particular ones of the video/still images 746 to insert 755 into a volumetric display via depth-producing element 730. In some cases, the interactive module 720 may actually modify the digital still/video images 746 prior to their being displayed 755 to enhance interactivity (e.g., to show a character talking in response to audio input from a viewer or the like). In other cases, the interactivity may include a viewer pressing a touchscreen to select or cause a particular image 746 to be played/displayed 755.

As described, autostereoscopic display systems include a stereoscopic panel combined with a 2D image source. Conventional stereoscopic panels may have opaque backings to reflect light to create a static/repeated display with depth in the form of 2, 3, or more static layers of imagery. In contrast, the stereoscopic panels utilize a backing that is translucent such that they reflect a quantity of light passing through front/projection surfaces (e.g., transparent lenticules/substrate of a lenticular sheet) and also allow projected light from the 2D image source (e.g., an LCD or other monitor or a projector) to pass through such that a volumetric display is achieved with two differing types of media delivery (passive and active/controlled delivery).

The 2D imaging source may be thought of as actively imaging onto translucent/static depth images. In one embodiment, no masks are used for at least some of the “images” provided by the 2D imaging source, e.g., projecting light or imagery that may be animated to vary its X-Y coordinates on the projection plane such that it moves among layers of the static images. In other cases, the static images/layers are used to build masks that are applied to the content of the 2D image source. These may be considered “precision masked projection” embodiments that project only in certain areas of the static imagery (or Z space created by the stereoscopic panel), e.g., light is masked such that images are not projected in particular (masked) areas of the projection plane.

The display systems described herein provide a number of advantages over prior volumetric display devices. The display system described provides an ability to create depth and dimension with 2D media in an autostereoscopic manner by combining the 2D media with a passive stereoscopic print (or panel including such a print/artwork). The display systems are extremely cost effective (no need for 3D media, special projection equipment, 3D viewing glasses, and so on) and have little or no maintenance needs. The display systems may be scaled very effectively such as from a small movie or attraction poster to a large set backdrop in an attraction or other setting. With use of a high-brightness emissive display as the 2D image source, the display systems are useful in high light settings such as outside in the sunlight. In contrast to solely static displays, the display systems provide the ability to deliver either informational or story-driven content in an interesting/attention-grabbing way almost anywhere. The display systems do not require specialized media as media provided by 2D image source may be in a standard format (e.g., 2D media that is optionally masked to suit the static depth-providing image elements). The display systems also may be configured to have a real time interactive element (e.g., select 2D media based on user input, modify displayed 2D media in real time in response to particular user input, and the like).

We claim:

1. An autostereoscopy apparatus, comprising:
a passive autostereoscopic panel with a front surface, a back surface, and at least one ink layer providing a plurality of static images, the autostereoscopic panel reflecting light striking the front surface to display a three dimensional (3D) display of images based on the static images; and
an image source projecting two dimensional images onto the back surface, wherein the back surface is non-opaque whereby the two dimensional images are projected outward from the front surface within the 3D display.

2. The apparatus of claim 1, wherein a portion of the two dimensional images are video images.

3. The apparatus of claim 2, wherein the video images are masked based on at least one of the static images such that the video images are displayed within a display area that is a smaller subset of a projection surface corresponding to the front surface.

4. The apparatus of claim 3, wherein at least one of the video images is displayed over a range of X-Y coordinates of a projection surface corresponding to the front surface, whereby displayed images associated with the at least one of the video images are displayed in two or more layers of the 3D display.

5. The apparatus of claim 1, wherein the autostereoscopic panel comprises a lenticular sheet including lenticules on the front surface with the static images provided as sets of interlaced images and wherein the back surface is provided by a backing layer covering the ink layer that is at least partially translucent.

6. The apparatus of claim 1, wherein the image source comprises an emissive display with a display surface positioned proximate to the back surface of the auto stereoscopic panel.

7. The apparatus of claim 6, wherein the emissive display comprises a liquid crystal display (LCD), a plasma display, or a projector.

8. An apparatus for generating a volumetric display, comprising:
a passive depth-producing element with a front surface and a rear surface, wherein the passive depth-producing element is responsive to light from a light source external to the apparatus to display at least a background image and a foreground image at differing depths relative to the front surface;
a source of digital media including a two-dimensional video image; and
an emissive display with a monitor screen and communicating with the digital media source, the emissive display displaying the two-dimensional video image via the monitor screen, wherein the monitor screen is positioned adjacent the rear surface of the passive depth-producing element.

9. The apparatus of claim 8, wherein the two-dimensional video image is configured to move between a position proximate to the background image and a position proximate to the foreground image, whereby a volumetric display is provided including the background image, the foreground image, and the two-dimensional video image that appears to have changing positions within the Z plane due to the movement relative to the background and foreground images.

10. The apparatus of claim 8, wherein the two-dimensional video image is masked based on at least one of the background and foreground images to be projected from predefined areas of the front surface of the passive depth-producing element.

11. The apparatus of claim 10, wherein the predefined areas for projection include areas where the at least one of the background and foreground images are not displayed from the front surface of the passive depth-producing element.

12. The apparatus of claim 8, wherein the emissive display comprises an LCD or plasma display device and wherein the rear surface is non-opaque to light emitted from the monitor screen.

13. The apparatus of claim 8, wherein the passive depth-producing element comprises a lenticular sheet with lenticules on the front surface and comprises an ink layer proximate to the rear surface including interlaced images corresponding to the background and foreground images.

14. An autostereoscopic display method, comprising:
positioning a stereoscopic panel in an area with a light source, wherein the stereoscopic panel displays a volumetric display in response to light from the light source that includes at least two static printed images at differing depths along the Z plane relative to the stereoscopic panel and wherein the stereoscopic panel has a backing that is at least partially translucent to light; and
projecting light through the backing of the stereoscopic panel, wherein the projected light is visible by a viewer of the stereoscopic panel in the volumetric display and wherein the projected light is moved, during the projecting, at least from first to second positions within the volumetric display.

15. The method of claim 14, wherein the first and second positions correspond to X-Y coordinates in a plane orthogonal to the Z plane.

16. The method of claim 14, wherein the projected light comprises 2D video images, whereby a dynamic image is inserted into the volumetric display.

17. The method of claim 16, wherein the light projecting step is performed by an emissive display with a display screen positioned adjacent the backing of the stereoscopic panel.

18. The method of claim 16, further comprising receiving user input and, prior to the projecting step, modifying or selecting the 2D video images based on the received user input.

19. The method of claim 16, wherein the 2D video images are masked using at least one of the static printed images.

20. The method of claim 14, wherein the stereoscopic panel comprises a lenticular sheet with a layer of interlaced images corresponding to the static printed images and a backing layer of non-opaque material corresponding to the backing of the stereoscopic panel.
